(19) United States
(12) Patent Application Publication
(10) Pub. No.: US 2007/0195882 A1
(43) Pub. Date: Aug. 23, 2007

(54) Video decoder with scalable compression and buffer for storing and retrieving reference frame data

(75) Inventors: Johannes Yzebrand Tichelaar, Eindhoven (NL); Peter Hubertus Frencken, Eindhoven (NL); Remco Schutte, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.V. a Corporation

(21) Appl. No.: 10/592,187

(22) PCT Filed: Feb. 23, 2005
(86) PCT No.: PCT/IB05/50650

§ 371 Date: Sep. 8, 2006

(30) Foreign Application Priority Data
Mar. 8, 2004 (EP) 04100926.7

(51) Int. Cl. H04N 11/02

(52) U.S. Cl. 375/240.16; 375/240.25

(57) ABSTRACT

The present invention relates to a video decoder having means for compressing reference frame data (6) using a scalable compression method. The video decoder further having buffer means (8) for intermediate storing of at least the vertical aperture (range) of motion vectors plus one row (slice) of macro blocks in lines of video per reference frame. Further it includes means for decompressing reference frame data (7) for enabling means for motion compensation (10) of said decoder to reconstruct vector predicted pictures and macro blocks utilizing said decompressed reference frame data. The present invention also relates to a method to be implemented by such a video decoder.

The present patent application relates to the field of video decoders and in particular to video decoders having a simplified memory access profile.

In the field of digital video the most prevalent picture coding types are: I-pictures (intra-coded pictures) which are coded without reference to any other pictures and are often referred to as reference or anchor frames; P-pictures (predictive-coded pictures) which are coded using motion-compensated prediction from the past I- or P-reference picture, and may also be considered reference or anchor frames; and B-pictures (bidirectionally predictive-coded pictures) which are coded using motion compensation from a previous (backward) and a future (forward) I- or P-picture. These picture types will sometimes also be referred to as I, P or B frames.

A compression standard referred to as MPEG (Moving Pictures Experts Group) compression is a set of methods for compression and decompression of full motion video images which uses the frame compression techniques described above. MPEG compression uses both motion compensation and discrete cosine transform (DCT) processes, among others, and can yield very high compression ratios. For better understanding of this compression standard, reference is made to “Digital Video: An Introduction to MPEG-2” by Barry G. Haskell, Atul Puri, and Arun N. Netravli, published by Chapman & Hall in 1997.

Presently most video decoders, such as MPEG-2 decoders, use external memory to create video frames from P-pictures and B-pictures by vector-controlled prediction to previously stored reference frames. This external memory is most likely DRAM-based because those represent the mainstream market of stand-alone memory devices. DRAM-based memories provide a burst-access mode to obtain a high bandwidth performance. This means that a number of consecutive data words (burst) are transferred to or from memory by giving only a single read or write command. To exploit the available data bandwidth the read and write accesses have to be burst-oriented. DRAM-based memories tends to have efficient memory transfers for large-size bursts only.

A first disadvantage is that vector-controlled prediction requires random positioned block-based access to one or more reference frames in memory. The efficiency for such access to and from DRAM-based memories is rather low. A second disadvantage is the video content dependent dynamics in required memory access bandwidth for reconstructing vector predicted frames.

Although many digital systems use MPEG-2 as compression standard there is a market differentiation between so-called main-level and high-level systems. Not only the encoder but also the decoder implementations for both systems are quite different. The difference in processing speed and memory requirement is a factor five to six. Another fast upcoming market differentiation is between systems (on chip) that can do single high-level decoding and double high-level decode. In the case of dual high-level MPEG-2 decoding, one or more state of the art MPEG-2 decoders will claim considerable system resources like in particular memory bandwidth to external memory and memory footprint for reference frame storage.

Due to improvements in mainstream CMOS performance, the high decoding speed has not resulted in a six times larger decoding block for high-level systems. Unfortunately, the memory requirements scale linearly in both access bandwidth and capacity thus having a bigger impact on the decoder architecture. Especially the difference in access bandwidth will imply a different approach in the case of external memories. This is complicated even further if the external memory has to be shared with other clients like CPU, scaler, graphics accelerators, image composition processors, etc. Memory resource sharing with other clients is a typical situation when the MPEG decoder is part of a system-on-chip, which uses unified external memory.

Previously known patent publication U.S. Pat. No. 6,088,391 relates to a memory system for B frames of pixel data, where each B frame includes a plurality of sections, and where each of the plurality of sections includes pixel data corresponding to the top and bottom fields of a frame. The memory system includes a memory organized into a plurality of segments for storing the pixel data, where the number of segments equals the number of frame sections plus two additional segments. However, each of the segments is half the size of a frame section. The memory system also includes a segmentation device for receiving and separating pixel data according to the top and bottom fields of each frame. The segmentation device tracks the segments to determine two available segments of said memory, and for each section of each frame, stores pixel data from the top field into one of the available segments and stores pixel data from the bottom field into the other available segment of the memory. A segment pointer table is preferably included for tracking the segments of memory for interlaced display. A decoder system includes the memory and the segmentation device, and also includes a reconstruction unit for receiving and decoding video data into pixel data, and display circuitry for retrieving pixel data from the segments. A method of storing and retrieving pixel data includes steps of separating and storing the pixel data by field into respective segments. After half a frame store, the data is retrieved by a display device for interlaced display.

A drawback of the above described decoder system and method according to U.S. Pat. No. 6,088,391 is that it only allows for partial reduction of memory size requirements but does not reduce memory bandwidth requirements, does not simplify the memory access profile, and does not reduce the dynamics in required memory access bandwidth.

Accordingly, there is a need for a video decoder and associated method implemented thereby, through which the memory access profile is simplified, the dynamics in memory access bandwidth is reduced, and further reduction of memory size requirements and memory access bandwidth can be achieved.

Taking the above into mind, it is an object of the present invention to provide an improved video decoder having an integrated memory buffer in combination with data compression and decompression, by which a simple access profile to external memory and low and fully deterministic memory access bandwidth to external memory can be achieved independent of video content.

This object is achieved in accordance with the characterizing portion of claim 1.

Thanks to the provision of means for compressing reference frame data using a scalable compression method; buffer means for intermediate storing of at least the vertical aperture (range) of motion vectors plus one row (slice) of macro blocks in lines of video per reference frame; means for decompressing reference frame data for enabling said means for motion compensation (MC) to reconstruct vector predicted pictures and macro blocks utilizing said decompressed reference frame data, both the size of reference frames to be stored and the memory access bandwidth requirements are reduced.

A further object of the present invention is to provide a method for simplifying the memory access profile and reducing the memory access bandwidth in a video decoder having an integrated memory buffer in combination with data compression and decompression, by which a simple access profile to external memory and low and fully deterministic memory access bandwidth to external memory can be achieved independent of video content.

This object is achieved in accordance with the characterizing portion of claim 18.

Thanks to the provision of steps for: variable length decoding (VLD) of compressed video data; inverse scan, inverse quantization, and Inverse Discrete Cosine Transformation (IDCT) decoding of intra coded pictures, intra coded macro blocks, and intra coded delta information; motion compensation for decoding vector predicted pictures and macro blocks; combining decoded intra-coded macro blocks, decoded intra-coded delta information, and motion compensated vector predicted macro blocks into reference frame or output frame data; compressing reference frame data using a scalable compression method; intermediately storing of at least the vertical aperture (range) of motion vectors plus one row (slice) of macro blocks in lines of video per reference frame in buffer means; decompressing reference frame data for enabling said means for motion compensation (MC) to reconstruct vector predicted pictures and macro blocks utilizing said decompressed reference frame data; outputting decoded picture data, both the size of reference frames to be stored and the memory access bandwidth requirements are reduced.

Preferred embodiments are listed in the dependent claims.

In the drawings, wherein like reference characters denote similar elements throughout the several views:

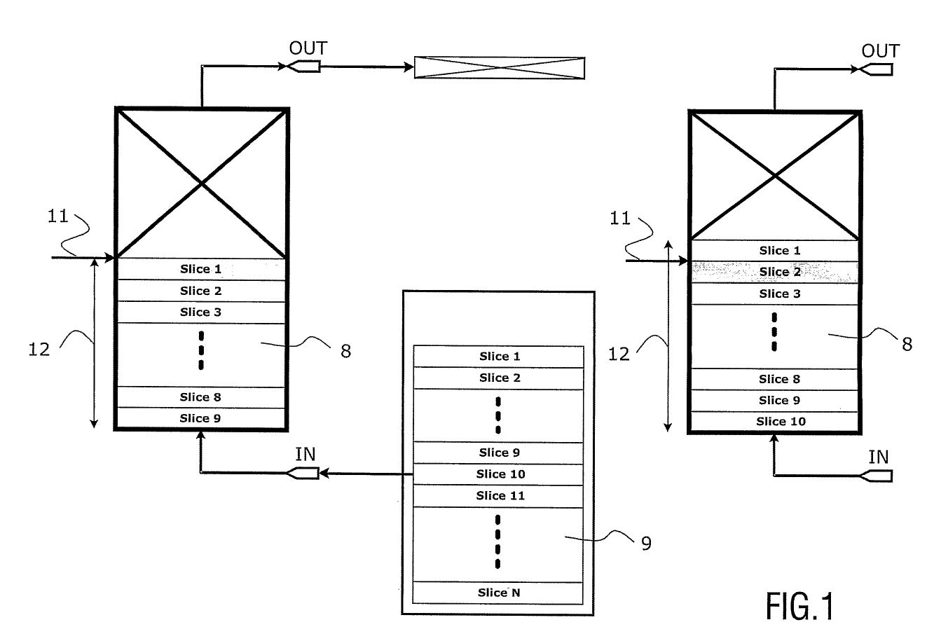

FIG. 1 shows the initialization and update strategy for a FIFO;

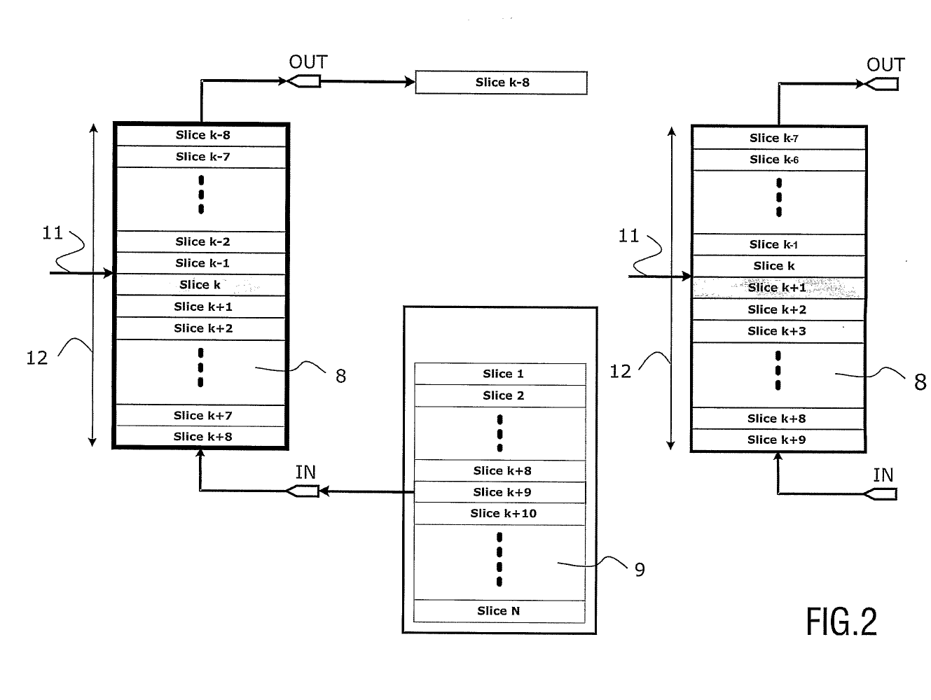

FIG. 2 further illustrates the initialization and update strategy for a FIFO in accordance with FIG. 1;

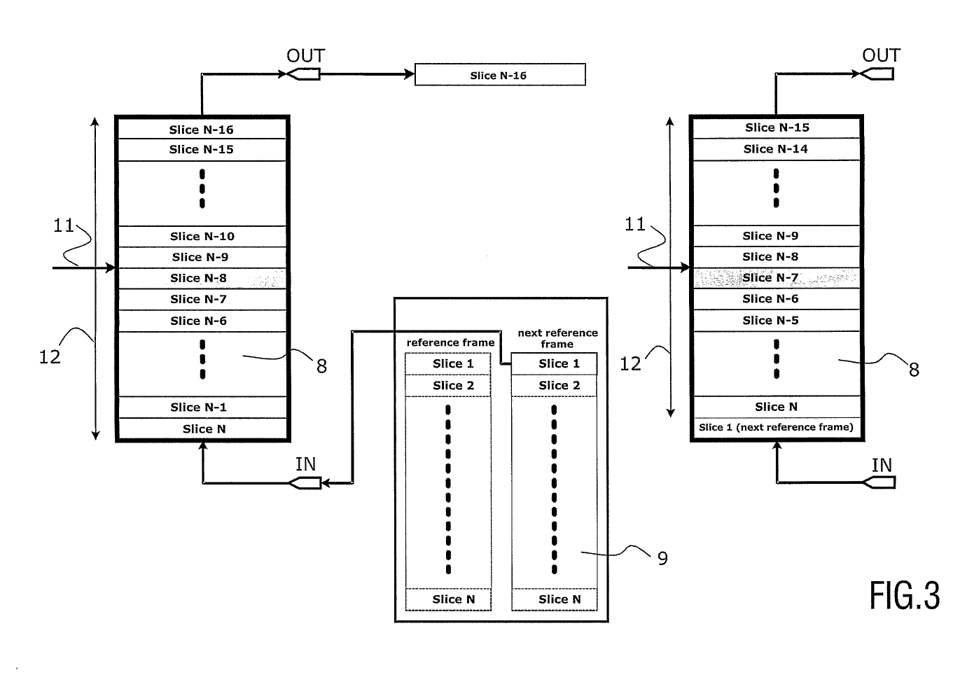

FIG. 3 further illustrates the initialization and update strategy for a FIFO in accordance with FIG. 1 and FIG. 2;

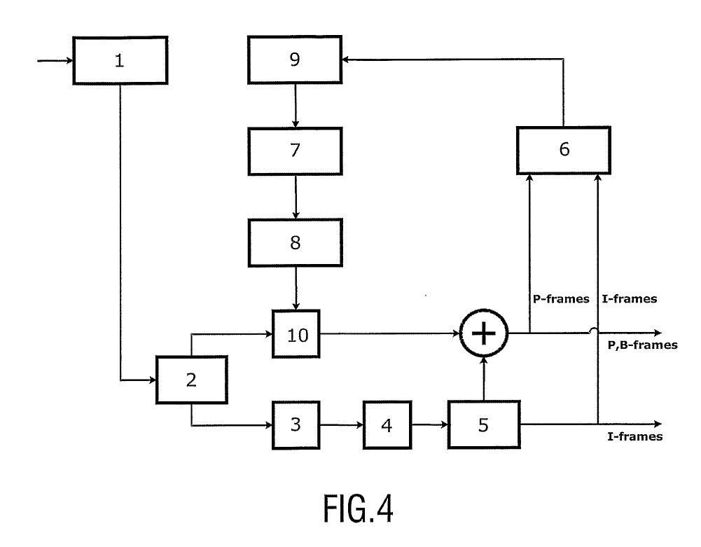

FIG. 4 discloses a schematic view of a video decoder in accordance with a first embodiment of the present invention;

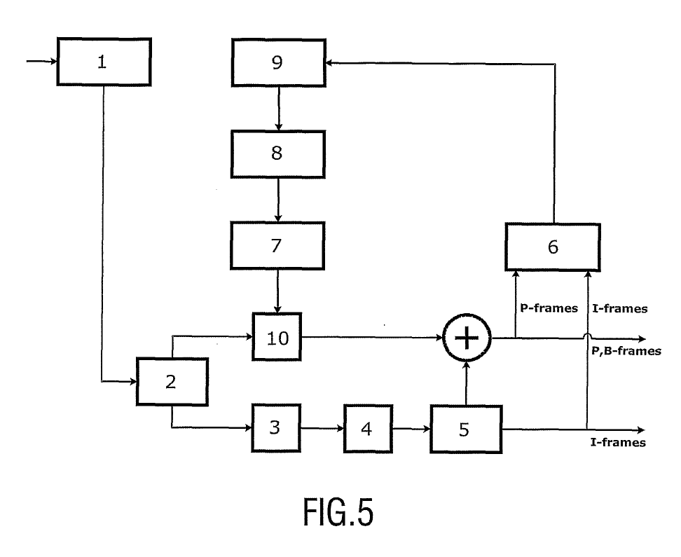

FIG. 5 discloses a schematic view of a video decoder in accordance with a second embodiment of the present invention;

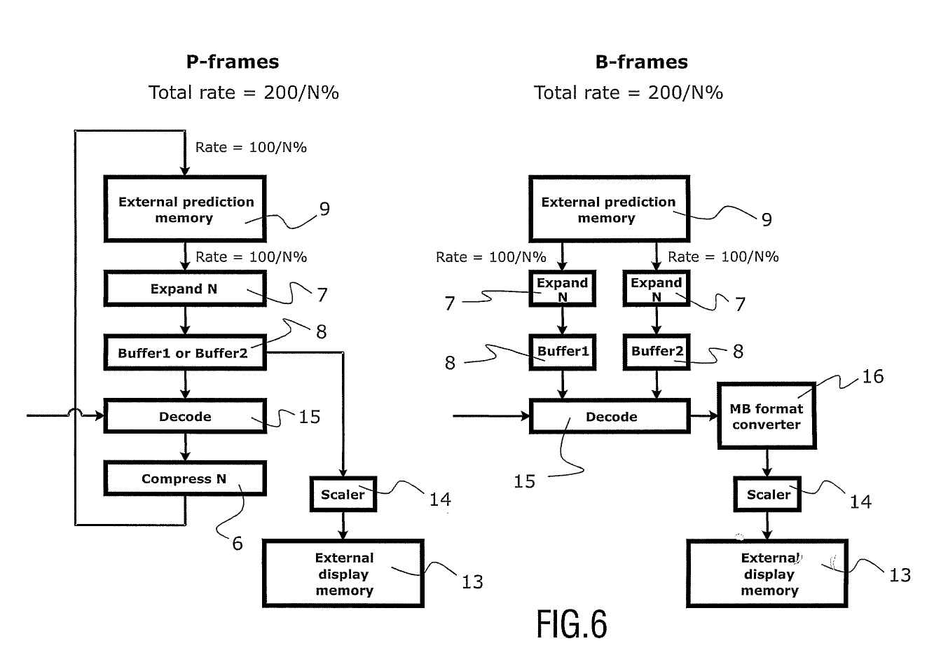

FIG. 6 illustrates how the size of the reference frames has been reduced by the compression ratio as well as the memory access bandwidth;

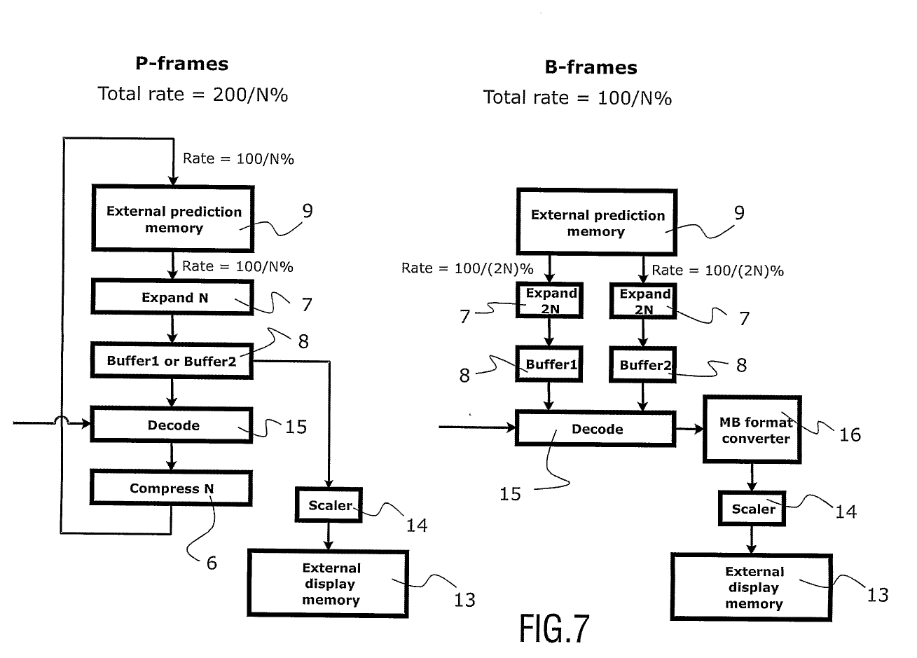

FIG. 7 illustrates a preferred embodiment where reference frames for P-pictures are a factor two less compressed than those for B-pictures;

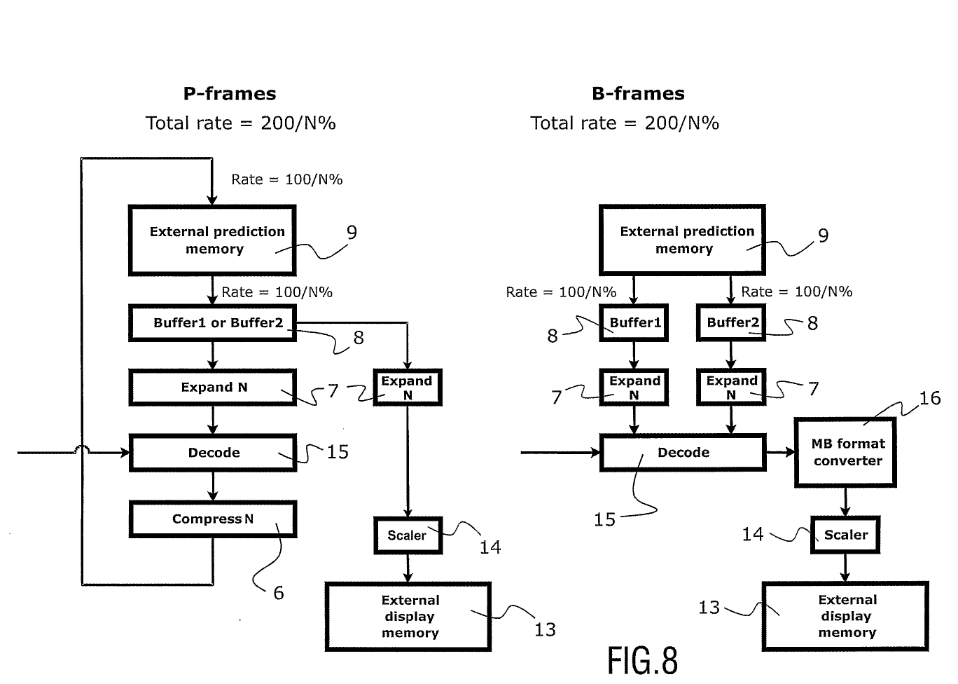

FIG. 8 illustrates a general concept of the second embodiment;

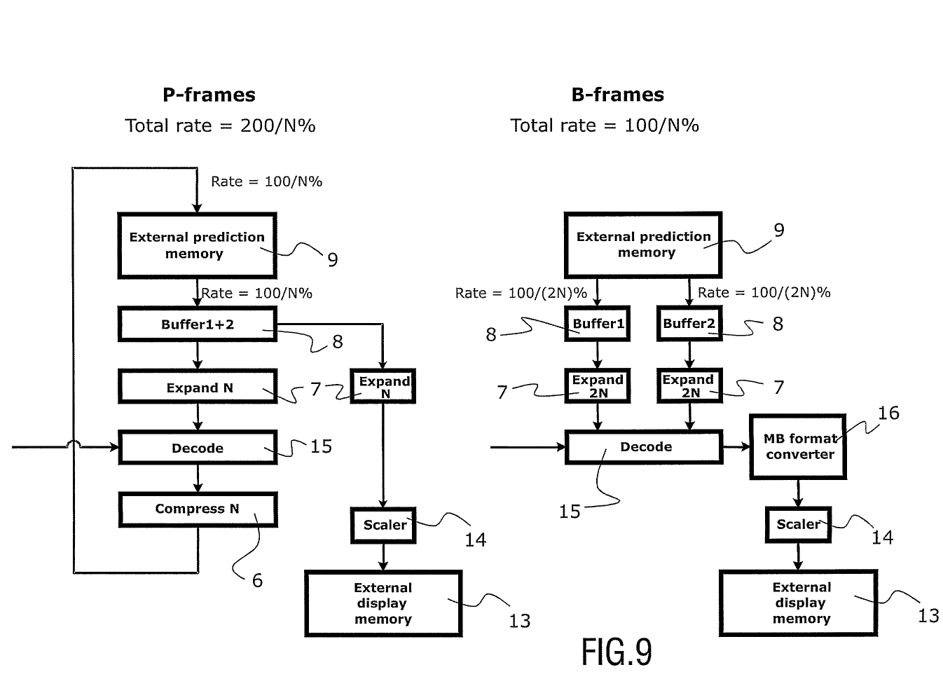

FIG. 9 illustrates a preferred general concept of the second embodiment;

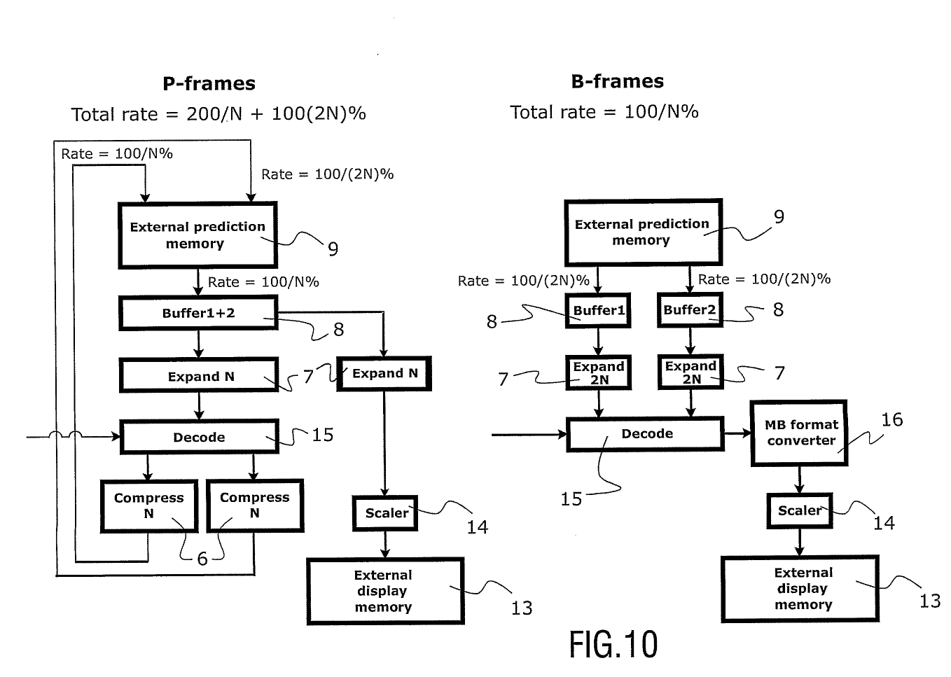

FIG. 10 illustrates a first alternative implementation option for the second embodiment;

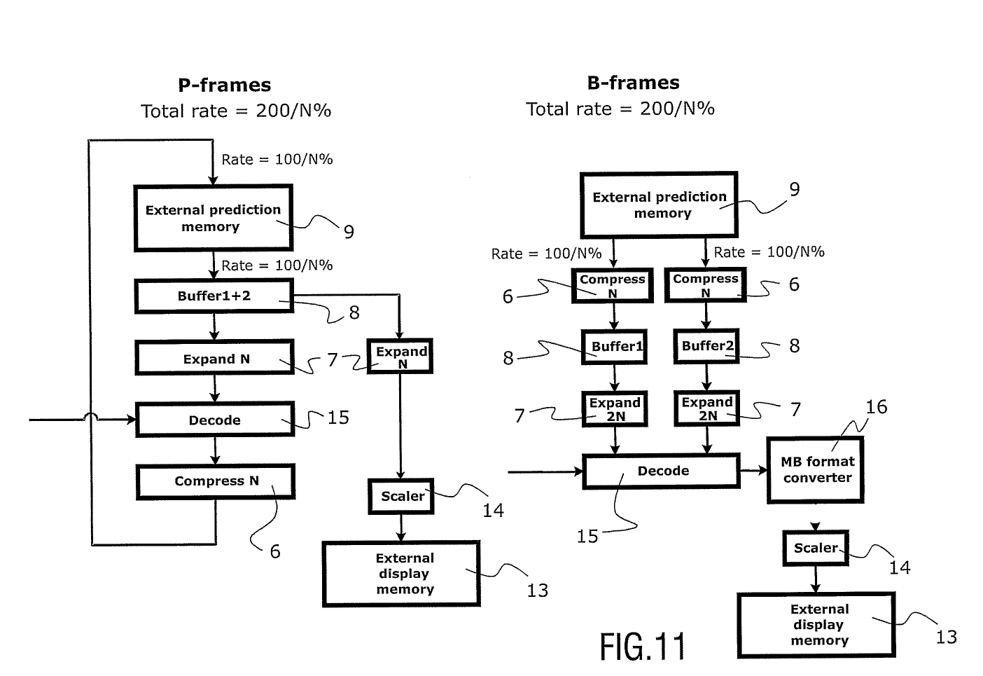

FIG. 11 illustrates a second alternative implementation option for the second embodiment.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

In order to simplify the external memory access profile and to remove the dynamics in required external memory access bandwidth by a video decoder, in accordance with the present invention it is proposed to integrate memory. This integrated memory is used as a buffer 8, which is accessed in a first-in, first-out (FIFO) mode when video data is transferred from the external memory 9 into the buffer, and is accessed block-based by for instance a pre-fetch unit of the device that constructs predicted frames by motion vectors in the video decoder. The function of the buffer 8 is to hide complex (vector controlled) memory access profiles and dynamics in memory access bandwidth from the external memory 9.

Actually, the buffer implements a FIFO per reference frame. Hence, in the case of a MPEG-2 decoder the buffer 8 will contain maximal two FIFO's. The preferred granularity of a FIFO element in the buffer 8 in FIFO mode is one slice, which is one row of macro blocks. It is assumed that one slice spans the full horizontal range of the picture. This assumption is not mend to be restrictive. Note that in practice the transfer of one slice (i.e. one FIFO element) takes several efficient burst accesses from external memory 9. A preferred further optimization is that one FIFO element expressed in number of bytes equals exactly the number of bytes that is acquired by an integer number of burst accesses from external memory 9.

FIG. 1 shows the initialization and update strategy for such a FIFO in the example case of ATSC high-level MPEG-2 decoding (vertical range about ±128, which is ±8 slices). In the figures the reference frame buffer (FIFO) is designated 8, a reference pointer is designated 11 and a vertical range motion vector 12, the external memory 9. Let's assume that the decoder starts to decode a vector predicted picture. Its macro blocks are input in consecutive order starting at the left top, scanning from left to right and thereby moving from top to bottom and ending in the right bottom corner. The initial condition is that the FIFO 8 is about half full (see FIG. 1, (left hand)), which is the upper part of the reference frame that span half motion vector's 12 vertical aperture and one slice in addition. The first input slice (Slice 1) of the vector predicted picture can be fully processed since all possible vector referenced picture data is exactly in the FIFO 8. The next slice of the reference frame has to be transferred from external memory 9 into the FIFO 8 when the first macro block of the second slice (Slice 2) of the vector predicted picture has to be decoded (see FIG. 1 center and right). Since the FIFO 8 is about half full either no FIFO element is dropped yet or old data is dropped. This process continues up until the vertical offset from the top of an input slice goes beyond half the vertical aperture. From this point onwards the vector predicted picture being decoded will never reference the first slice in the FIFO 8 so that this first slice is dropped. The second slice in the FIFO 8 is dropped when the next slice of the vector predicted picture is decoded, and so on as shown in FIG. 2. This continues up until the last slice of the reference frame is in the FIFO 8.

An advantageous approach for the run-out situation of the present reference frame in the FIFO 8 is to have video data of the next required reference frame already in place in the FIFO 8 when the decoding starts of the next vector predicted picture. This can be achieved by loading the first slice of a next required reference frame into the FIFO 8 when the present slice of the vector predicted picture has been decoded and the next slice is still to be decoded as shown in FIG. 3. When the last slice of the predictive picture has been decoded, the situation is as in FIG. 1 but with the first part of the next required reference frame in FIFO buffer 8.

In the case of MPEG-1 and MPEG-2 the buffer size, in bits, should be larger or equal to:
(the vertical range of a motion vector+one row of macro blocks, which spans the full horizontal size of the picture)×the maximum number of pixels per line×the maximum number of reference frames×the number of bytes per pixel×the number of bits per byte when assuming that the video in the buffer 8 is uncompressed.

A single high level MPEG-2 decoder for ATSC has a vertical range of a motion vector of 256, requires 16 lines for a macro block row, has a maximum of 1920 pixels per line, has maximal 2 reference frames, 1.5 bytes per pixel, and obvious 8 bits per byte. Hence, about 13 Mbit of buffer memory has to be integrated when no data compression is applied for a single-high level MPEG-2 decoder. This 13 Mbit of memory can be integrated with a high speed MPEG decoding pipe in one block. Such a block can cope with main level decoding in 50/60 Hz without requiring external memory 9. In the case of high-level decoding the buffer 8 is used for vector-controlled prediction, which is the most access intensive operation. The missing memory capacity should be added externally but requires only a very simple, minimal bandwidth, interface. The output of the decoder must, in both cases, be fed via en external display memory 13 to the output during which stage it can be mixed with graphics and other video streams. In some main-level systems the display memory 13 can even be fully omitted.

Due to the simple access profile to external memory 9, it is suggested in accordance with the present invention to add a block based memory compression algorithm for compression and decompression to and from the external memory 9. Any block based memory compression algorithm can be added. However, scalable compression algorithms are preferred, e.g. such as described in WO 0117268 A1, the teachings of which are hereby incorporated by reference.

A video decoder in accordance with a first embodiment is illustrated schematically in FIG. 4. The decoder is preferably a MPEG decoder. It is noted, however, that the present invention is not limited to MPEG and may be used for any particular video standard or configuration. The video decoder in accordance with the present invention is based on a state of the art video decoder. Compressed video data is retrieved from a compressed data memory 1 and entropy decoded by a variable length decoder (VLD) 2, which converts the data to Discrete Cosine Transform (DCT) data. An inverse scanner (IS) 3, inverse quantizer (IQ) 4 and Inverse Discrete Cosine Transform (IDCT) 5 process the intra-coded delta information, and converts the data to macro blocks of pixel data. A macro block (MB) is the basic coding unit for the MPEG standard. A macro block consists of a 16-pixel by 16-line portion, or four 8-pixel by 8-line blocks, of luminance components (Y) and several spatially corresponding 8 by 8 blocks of chrominance components Cr and Cb. The number of blocks of chrominance values depends upon which particular format is used. The vector predicted frames are reconstructed either by block-based fetches from external prediction memory 9 by the motion compensator 10 and addition of delta information when present, or intra-coded macro blocks.

Such a state of the art MPEG-2 decoder would require a maximum theoretical rate from the external prediction memory 9 that is 200% the video rate. E.g. high-definition video with formats 1920×1080 interlace at 60 Hz has a net rate (no blanking) of about 62.2 Mpixel/s, which is about 93.3 Mbyte/s (assuming YUV 4:2:0 format). Hence, in this case a state of the art high-level MPEG-2 decoder requires in theory a maximum of 187 Mbyte/s memory access bandwidth. However, systems-on-chip have to use a much worse case figure due to the complicated memory access profile and SDRAM being efficient for large packets only.

In accordance with the present invention a video data compressor 6, a video data decompressor 7, and a buffer 8 have been added to the state of the art decoder, as illustrated in FIG. 5. The compressor 6 is arranged to compress reference frame data using a scalable compression method where after said compressed reference frame data will be stored in external memory means 9 providing a compressed reference frame memory. Compressed reference frame data is then retrieved from said external memory 9 and at least the vertical aperture (range) of motion vectors plus one row (slice) of macro blocks in lines of video per reference frame is intermediately stored in the buffer 8, which is arranged between the external memory 9 and means for motion compensation 10. Reference frame data is decompressed by the decompressor 7 for enabling the means for motion compensation (MC) 10 to reconstruct vector predicted pictures and macro blocks utilizing said decompressed reference frame data.

The size of the buffer 8 can in one example be equal to (2×128+16)×1920×1.5×2×8=12.53376×10⁶ bit for decoding plus preferably 16×1920×1.5×8≈0.4×10⁶ bit for line-to-line conversion buffering when a scaler 14 is integrated, i.e. in total approximately 13 Mbit. The access profile to external memory 9 is very simple. However, the size of the reference frames has been reduced by the compression ratio as well as the memory access bandwidth, as is illustrated in FIG. 6. In FIG. 6 the decoding block is designated 15 and a MB format converter 16. Note that in FIG. 6 only half of the buffer 8 is used for storing one required reference frame. FIG. 7 illustrates a preferred embodiment where reference frames for P-pictures are a factor two less compressed than those for B-pictures. The preferred scalable compression method of FIG. 7 has the property that a ratio 2N:1 compressed data is simply obtained by taking the appropriate half most significant data of ratio N:1 compressed data. Those skilled in the art can map most significant and least significant compressed data in memory such that a simple access profile and efficient memory access to external memory 9 is obtained. Note that the factor two and the two hierarchical levels can be extended to non-factor two and multi hierarchical levels.

In a second embodiment, according to FIG. 5, the size of the buffer 8 can be further reduced when data compression/decompression is applied in a slightly different manner than as stated above. Data compression is applied on decoded reference frames prior to transfer to the external memory 9. However, data decompression is applied on data fetched from the buffer 8, which thus contains compressed reference frame(s) data. This compressed data has been loaded from the external memory 9 to the buffer 8. The data compression method has preferably the requirements of reasonable compression factor, low implementation costs, very high quality, robustness for repetitive coding/decoding, and easy pixel access. Reasonable data compression ratios at acceptable implementation costs and sufficient high subjective picture quality are 2:1 and 4:1. A compression ratio of 2:1 is regarded as lossless and a ratio of 4:1 is regarded as very high quality by those skilled in the art. In the MPEG-2 standard a large number of P-pictures can be coded subsequently such that certain macro blocks are compressed and decompressed repeatedly by the codec. To prevent that the decoder would drift away from the local reconstruction loop as applied in the encoder accurate quantization should be performed. Easy access to the pixels in the compressed domain should be possible to enable real-time operation of the motion compensated mechanism.

Another advantage provided by the present invention is that, in using a buffer 8 in combination with compression and decompression, reference frames for P-pictures and B-pictures can be given different compression ratios. P-pictures require in principle less impaired and hence less compressed reference frames than B-pictures because of consecutive prediction of P-pictures and therefore the risk of cumulating errors due to the compression. E.g., the required buffer size for a high-level MPEG-2 decoder is reduced from about 13 Mbit to about 3 Mbit when a 2:1 compressed reference frame is used for reconstructing P-pictures and two 4:1 compressed reference frames are used for reconstructing B-pictures. The advantage of using scalable compression is that 2:1 compressed reference frames have to be stored in memory only. A scalable compression method makes it very easy to obtain the required 4:1 compressed reference frames directly from the 2:1 compressed reference frames, which feature is known to those skilled in the art. E.g., the 2:1 compressed reference frame can be split into two half planes. The first containing most significant data, which represents 4:1 compression ratio and the second containing least significant data, which combined with the first represents 2:1 compressed reference frame. It is obvious to those skilled in the art that more levels of hierarchy can be introduced or other factors than two implemented.

Thus, the decoder in accordance with the present invention can decode double high-level MPEG-2, single high-level MPEG-2, and at least dual main-level MPEG-2 at relative low memory access bandwidth and easy access profile to the external memory. The embodiment of using less compressed reference frames for recursive used vector predicted pictures (e.g. P-pictures) than for non-recursive used vector predicted pictures (e.g. B-pictures) could also be used without buffer (8). The advantage is a potential reduction in memory access bandwidth and no need for an integrated buffer (8). However, the disadvantage is that the memory access profile to external memory is not simplified.

FIG. 5 illustrates schematically a video decoder in accordance with a second embodiment of the present invention. This second embodiment is preferred when the buffer size has to be reduced in comparison to the first embodiment as described above. The prediction of frames is buffered. The buffer 8 contains compressed video data, which is decompressed by the decompressor 7 prior to the construction of the predicted frame. In an example the amount of buffer memory for decoding is equal to (2×128+16)×1920×1.5×2×8/C in bits where C is the compression ratio. E.g. the size of the buffer 8 can be restricted to 3.3 Mbit instead of about 12.6 Mbit when a compression ratio of 4:1 is applied on reference frames. The general concept is illustrated in FIG. 8.

Another advantage of this second embodiment is that a reference frame for a P-picture can be compressed at a smaller compression ratio than reference frames for B-pictures since only one reference frame is needed. With the same amount of memory reference frames for P-pictures can have up to a factor two less compression than reference frames for B-pictures.

The preferred general concept of the second embodiment is illustrated in FIG. 9. E.g. 4:1 ratio compression on both reference frames for a B-picture and minimum a 2:1 compression on a reference frame for a P-picture. Note that storage of reference frames compressed by 2:1 ratio only is possible when scalable compression has been applied. The advantage is that consecutive predictive P-pictures are processed with less compression and hence less impairments. B-pictures are non consecutive predicted and hence can be more impaired and thus may have larger compression ratios. The disadvantage is twice as large memory footprint for the compressed reference frames.

A similar calculation results in 2.1 Mbit buffer memory when having compression ratios of 6:1 and 3:1 respectively for B-pictures and P-pictures. FIGS. 10 and 11 illustrate different implementation options for the same basic concept.

The present invention further relates to a method for simplifying the memory access profile and reducing the dynamics in memory access bandwidth to reference frame memory in a video decoder comprising the steps of: variable length decoding (VLD) of compressed video data; inverse scan, inverse quantization, and Inverse Discrete Cosine Transformation (IDCT) decoding of intra coded pictures, intra coded macro blocks, and intra coded delta information; motion compensation for decoding vector predicted pictures and macro blocks; combining decoded intra-coded macro blocks, decoded intra-coded delta information, and motion compensated vector predicted macro blocks into reference frame or output frame data; compressing reference frame data using a scalable compression method; intermediately storing at least the vertical aperture (range) of motion vectors plus one row (slice) of macro blocks in lines of video per reference frame in buffer means; decompressing reference frame data for enabling said means for motion compensation (MC) to reconstruct vector predicted pictures and macro blocks utilizing said decompressed reference frame data; outputting decoded picture data.

In one embodiment the above method further comprises the steps of: storing said compressed reference frame data in external memory means; retrieving said compressed reference frame data from said external memory means; decompressing said retrieved reference frame data; intermediately storing in said buffer means said decompressed reference frame data; reconstructing vector predicted pictures and macro blocks utilizing said decompressed reference frame data.

In an alternative embodiment the above method further comprises the steps of: storing said compressed reference frame data in external memory means; retrieving said compressed reference frame data from said external memory means; intermediately storing in said buffer means said compressed reference frame data; decompressing said intermediately stored reference frame data; reconstructing vector predicted pictures and macro blocks utilizing said decompressed reference frame data.

In an alternative embodiment the above method further comprises the steps of: compressing a reference frame at a first compression ratio and a second compression ratio; reconstructing vector predicted pictures to be used as reference frames by reference frames compressed at said first compression ratio and vector predicted pictures that are not to be used as reference frames by reference frames compressed at said second compression ratio.

In yet an alternative embodiment the above method further comprises the steps of: compressing a reference frame at a first compression ratio and a second compression ratio; reconstructing P-pictures by reference frames compressed at said first compression ratio and B-pictures by reference frames compressed at said second compression ratio.

In still an alternative embodiment of the above method said first compression ratio is less than or equal to said second compression ratio.

In another alternative embodiment of the above method said first compression ratio is half of said second compression ratio.

In still another alternative embodiment of the above method said first compression ratio is 2:1 and said second compression ratio is 4:1.

In yet still another alternative embodiment of the above method said first compression ratio is 3:1 and said second compression ratio is 6:1.

In a still further alternative embodiment of the above method said first compression ratio is 4:1 and said second compression ratio is 8:1.

In yet another alternative embodiment the above method further comprises the steps of: deriving data for a reference frame compressed with said second compression ratio directly from data for the same reference frame being compressed with said first compression ratio; intermediately storing in said external memory means only data for said reference frame at said first compression ratio.

In still yet another alternative embodiment the above method further comprises the step of: intermediately storing in said external memory means said compressed reference frame data for said reference frame being compressed with said first compression ratio hierarchically such that a first sub-image stored will contain most significant data representing the same reference frame compressed with a said second compression ratio being larger than said first compression ratio and a second sub-image such that it will contain least significant data, such that both sub-images together represent data for a reference frame compressed with said first compression ratio.

In a further alternative embodiment of the above method said second compression ratio is twice said first compression ratio.

In yet still yet another alternative embodiment the above method further comprises the step of: intermediately storing in said external memory means said compressed reference frame data for said reference frame being compressed with said first compression ratio hierarchically such that a first sub-image stored will contain most significant data representing the same reference frame compressed with a said second compression ratio being larger than said first compression ratio and a second sub-image such that it will contain least significant data, such that both sub-images together represent data for a reference frame compressed with said first compression ratio.

In yet another alternative embodiment the above method further comprises said buffer means being an integrated memory buffer.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A video decoder, comprising:
means for variable length decoding of compressed video data; means for inverse scan inverse quantization and Inverse Discrete Cosine Transformation decoding of intra coded pictures, intra coded macro blocks, and intra coded delta information; means for motion compensation for decoding vector predicted pictures and macro blocks; means for combining decoded intra-coded macro blocks, decoded intra-coded delta information, and motion compensated vector predicted macro blocks into reference frame or output frame data; characterized in that it further comprises;
means for compressing reference frame data using a scalable compression method; buffer means for intermediate storing of at least the vertical aperture of motion vectors plus one row of macro blocks in lines of video per reference frame;
means for decompressing reference frame data for enabling said means for motion compensation to reconstruct vector predicted pictures and macro blocks utilizing said decompressed reference frame data;
means for outputting decoded picture data.

2. The video decoder of claim 1, characterized in that it further comprises:
means for storing said compressed reference frame data in external memory means means for retrieving said compressed reference frame data from said external memory means
said means for decompressing reference frame data being arranged to decompress said retrieved reference frame data;
means for intermediately storing in said buffer means said decompressed reference frame data;
said means for motion compensation being arranged to reconstruct vector predicted pictures and macro blocks utilizing said decompressed reference frame data.

3. The video decoder of claim 1, characterized in that it further comprises:
means for storing said compressed reference frame data in external memory means
means for retrieving said compressed reference frame data from said external memory means
means for intermediately storing in said buffer means said compressed reference frame data;
said means for decompressing reference frame data being arranged to decompress said intermediately stored reference frame data;
said means for motion compensation being arranged to reconstruct vector predicted pictures and macro blocks utilizing said decompressed reference frame data.

4. The video decoder of any one of claim 2, characterized in said means for retrieving said reference frame data from said external memory being arranged to retrieve said data through repeated burst accesses of a predetermined number of consecutive data words; said buffer means being arranged to be accessed in a first-in, first-out FIFO mode, where the preferred granularity of a FIFO element in the buffer is one row of macro blocks, which spans the full horizontal range of the picture.

5. The video decoder of claim 4, characterized in that the size of one FIFO element, expressed in bytes, is arranged to equal exactly the number of bytes acquired by an integer number of burst accesses for retrieving data from said external memory means

6. The video decoder of any one of claims claim 2, characterized in said means for compressing reference frame data being arranged to compress a reference frame at a first compression ratio and a second compression ratio; said decoder being arranged to reconstruct-pictures by reference frames compressed at said first compression ratio and B-pictures by reference frames compressed with said second compression ratio.

7. The video decoder of claim 6, characterized in said first compression ratio being less than or equal to said second compression ratio.

8. The video decoder of claim 7, characterized in said first compression ratio being half of said second compression ratio.

9. The video decoder of claim 8, characterized in said first compression ratio being 2:1 and said second compression ratio being 4:1.

10. The video decoder of claim 8, characterized in said first compression ratio being 3:1 and said second compression ratio being 6:1.

11. The video decoder of claim 8, characterized in said first compression ratio being 4:1 and said second compression ratio being 8:1.

12. The video decoder of claim 6, characterized in said decoder being arranged to derive data for a reference frame compressed with said second compression ratio directly from data for the same reference frame being compressed with said first compression ratio; said means for intermediately storing in said external memory means said compressed reference frame data being arranged to only store data for said reference frame at said first compression ratio.

13. The video decoder of claim 12 characterized in said means for storing in said external memory means said compressed reference frame data being arranged to store data for said reference frame being compressed with said first compression ratio hierarchically such that a first sub-image stored will contain most significant data representing the same reference frame compressed wit 11 a said second compression ratio being larger than said first compression ratio and a second sub-image such that it will contain least significant data, such that both sub-images together represent data for a reference frame compressed with said first compression ratio.

14. The video decoder of claim 13 characterized in said second compression ratio being twice said first compression ratio.

15. The video decoder of claim 1 characterized in said buffer means having a capacity in bits of at least (the vertical range of a motion vector+one row of macro blocks, which spans the full horizontal size of the picture)×the maximum number of pixels per line×the maximum number of reference frames×the number of bytes per pixel×the number of bits per byte.

16. The video decoder of claim 1 characterized in said buffer means in the case of MPEG-1 or MPEG-2 video, having a capacity in bits of at least (the vertical range of a motion vector+one row of macro blocks, which spans the full horizontal size of the picture)×the maximum number of pixels per line×the maximum number of reference frames×the number of bytes per pixel×the number of bits per byte, per reference frame of minimum one reference frame and maximum two reference frames.

17. The video decoder of any one of claim 1 characterized in said buffer means being an integrated memory buffer.

18. A method for simplifying the memory access profile and reducing the dynamics in memory access bandwidth to reference frame memory in a video decoder, characterized in that it comprises the steps of:
variable length decoding of compressed video data;
inverse scan, inverse quantization, and Inverse Discrete Cosine Transformation decoding of intra coded pictures, intra coded macro blocks, and intra coded delta information;
motion compensation for decoding vector predicted pictures and macro blocks; combining decoded intra-coded macro blocks, decoded intra-coded delta information, and motion compensated vector predicted macro blocks into reference frame or output frame data;
compressing reference frame data using a scalable compression method;
intermediately storing at least the vertical aperture of motion vectors plus one row of macro blocks in lines of video per reference frame in buffer means;
decompressing reference frame data for enabling said means for motion compensation to reconstruct vector predicted pictures and macro blocks utilizing said decompressed reference frame data;
outputting decoded picture data.

19. The method of claim 18, characterized in that it further comprises the steps of:
storing said compressed reference frame data in external memory means;
retrieving said compressed reference frame data from said external memory means;
decompressing said retrieved reference frame data;
intermediately storing in said buffer means said decompressed reference frame data;
reconstructing vector predicted pictures and macro blocks utilizing said decompressed reference frame data.

20. The method of claim 18, characterized in that it further comprises the steps of:
storing said compressed reference frame data in external memory means;
retrieving said compressed reference frame data from said external memory means;
intermediately storing in said buffer means said compressed reference frame data;
decompressing said intermediately stored reference frame data;
reconstructing vector predicted pictures and macro blocks utilizing said decompressed reference frame data.

21. The method of any one of claim 19, characterized in that it further comprises the steps of:
retrieving said reference frame data from said external memory through repeated burst accesses of a predetermined number of consecutive data words;
accessing said buffer means in a first-in, first-out FIFO mode, where the preferred granularity of a FIFO element in the buffer is one row of macro blocks, which spans the full horizontal range of the picture.

22. The video decoder of claim 21, characterized in that it further comprises the step of:
arranging the size of one FIFO element, expressed in bytes, to equal exactly the number of bytes acquired by an integer number of burst accesses for retrieving data from said external memory means.

23. The method of any one of claim 19, characterized in that it further comprises the steps of: compressing a reference frame at a first compression ratio and a second compression ratio;
reconstructing vector predicted pictures to be used as reference frames by reference frames compressed at said first compression ratio and vector predicted pictures that are not to be used as reference frames by reference frames compressed at said second compression ratio.

24. The method of any one of claim 19, characterized in that it further comprises the steps of:
compressing a reference frame at a first compression ratio and a second compression ratio;
reconstructing P-pictures by reference frames compressed at said first compression ratio and B-pictures by reference frames compressed with said second compression ratio.

25. The method of any one of claim 23, characterized in said first compression ratio being less than or equal to said second compression ratio.

26. The method of any one of claim 23, characterized in said first compression ratio being half of said second compression ratio.

27. The method of claim 26, characterized in said first compression ratio being 2:1 and said second compression ratio being 4:1.

28. The method of claim 26, characterized in said first compression ratio being 3:1 and said second compression ratio being 6:1.

29. The method of claim 26, characterized in said first compression ratio being 4:1 and said second compression ratio being 8:1.

30. The method of any one of claim 23, characterized in that it further comprises the steps of: deriving data for a reference frame compressed with said second compression ratio directly from data for the same reference frame being compressed with said first compression ratio;
intermediately storing in said external memory means only data for said reference frame at said first compression ratio.

31. The method of claim 30 characterized in that it further comprises the step of:
intermediately storing in said external memory means said compressed reference frame data for said reference frame being compressed with said first compression ratio hierarchically such that a first sub-image stored will contain most significant data representing the same reference frame compressed with a said second compression ratio being larger than said first compression ratio and a second sub-image such that it will contain least significant data, such that both sub-images together represent data for a reference frame compressed with said first compression ratio.

32. The method of claim 31 characterized in said second compression ratio being twice said first compression ratio.

33. The method of any one of claim 30 characterized in that it further comprises the step of:
intermediately storing in said external memory means said compressed reference frame data for said reference frame being compressed with said first compression ratio hierarchically such that a first sub-image stored will contain most significant data representing the same reference frame compressed with a said second compression ratio being larger than said first compression ratio and a second sub-image such that it will contain least significant data, such that both sub-images together represent data for a reference frame compressed with said first compression ratio.

34. The method of any one of claim 18 characterized in said buffer means being an integrated memory buffer.

35. A video decoder, comprising:
means for variable length decoding of compressed video data;
means for inverse scan inverse quantization and Inverse Discrete Cosine Transformation decoding of intra coded pictures, intra coded macro blocks, and intra coded delta information;
means for motion compensation for decoding vector predicted pictures and macro blocks;
means for combining decoded intra-coded macro blocks, decoded intra-coded delta information, and motion compensated vector predicted macro blocks into reference frame or output frame data; characterized in that it further comprises;
means for compressing reference frame data using a scalable compression method;
said means for compressing reference frame data being arranged to compress a reference frame at a first compression ratio and a second compression ratio;
motion compensation to reconstruct vector predicted pictures and macro blocks utilizing said decompressed reference frame data;
means for outputting decoded picture data;
said decoder being arranged to reconstruct P-pictures by reference frames compressed at said first compression ratio and B-pictures by reference frames compressed with said second compression ratio.

36. The video decoder of claim 35, characterized in said first compression ratio being less than or equal to said second compression ratio.

37. The video decoder of claim 36, characterized in said first compression ratio being half of said second compression ratio.

38. The video decoder of claim 37, characterized in said first compression ratio being 2:1 and said second compression ratio being 4:1.

39. The video decoder of claim 37, characterized in said first compression ratio being 3:1 and said second compression ratio being 6:1.

40. The video decoder of claim 37, characterized in said first compression ratio being 4:1 and said second compression ratio being 8:1.

41. The video decoder of claim 35, characterized in said decoder being arranged to derive data for a reference frame compressed with said second compression ratio directly from data for the same reference frame being compressed with said first compression ratio; said means for intermediately storing in said external memory means said compressed reference frame data being arranged to only store data for said reference frame at said first compression ratio.

42. The video decoder of claim 41 characterized in said means for storing in said external memory means said compressed reference frame data being arranged to store data for said reference frame being compressed with said first compression ratio hierarchically such that a first sub-image stored will contain most significant data representing the same reference frame compressed with a said second compression ratio being larger than said first compression ratio and a second sub-image such that it will contain least significant data, such that both sub-images together represent data for a reference frame compressed with said first compression ratio.

43. The video decoder of claim 42 characterized in said second compression ratio being twice said first compression ratio.

44. A method for reducing memory access bandwidth to reference frame memory in a video decoder, characterized in that it comprises the steps of:
variable length decoding of compressed video data;
inverse scan, inverse quantization, and Inverse Discrete Cosine Transformation decoding of intra coded pictures, intra coded macro blocks, and intra coded delta information;
motion compensation for decoding vector predicted pictures and macro blocks; combining decoded intra-coded macro blocks, decoded intra-coded delta information, and motion compensated vector predicted macro blocks into reference frame or output frame data;
compressing reference frame data using a scalable compression method;
said compressing reference frame data at a first compression ratio and a second compression ratio;
decompressing reference frame data for enabling said means for motion compensation to reconstruct vector predicted pictures and macro blocks utilizing said decompressed reference frame data;
said reconstructing vector predicted pictures to be used as reference frames by reference frames compressed at said first compression ratio and vector predicted pictures that are not to be used as reference frames by reference frames compressed at said second compression ratio;
outputting decoded picture data;

45. The method of claims 44, characterized in that it further comprises the steps of:
compressing a reference frame at a first compression ratio and a second compression ratio;
reconstructing P-pictures by reference frames compressed at said first compression ratio and B-pictures by reference frames compressed with said second compression ratio.

46. The method of any of claim 44, characterized in said first compression ratio being less than or equal to said second compression ratio.

47. The method of claim 46, characterized in said first compression ratio being half of said second compression ratio.

48. The method of claim 47, characterized in said first compression ratio being 2:1 and said second compression ratio being 4:1.

49. The method of claim 47, characterized in said first compression ratio being 3:1 and said second compression ratio being 6:1.

50. The method of claim 47, characterized in said first compression ratio being 4:1 and said second compression ratio being 8:1.

51. The method of any one of claim 44, characterized in that it further comprises the steps of:
deriving data for a reference frame compressed with said second compression ratio directly from data for the same reference frame being compressed with said first compression ratio;
intermediately storing in said external memory means only data for said reference frame at said first compression ratio.

52. The method of claim 51 characterized in that it further comprises the step of:
intermediately storing in said external memory means said compressed reference frame data for said reference frame being compressed with said first compression ratio hierarchically such that a first sub-image stored will contain most significant data representing the same reference frame compressed with a said second compression ratio being larger than said first compression ratio and a second sub-image such that it will contain least significant data, such that both sub-images together represent data for a reference frame compressed with said first compression ratio.

53. The method of claim 52 characterized in said second compression ratio being twice said first compression ratio.

54. The method of any one of claim 51, characterized in that it further comprises the step of:
intermediately storing in said external memory means said compressed reference frame data for said reference frame being compressed with said first compression ratio hierarchically such that a first sub-image stored will contain most significant data representing the same reference frame compressed with a said second compression ratio being larger than said first compression ratio and a second sub-image such that it will contain least significant data, such that both sub-images together represent data for a reference frame compressed with said first compression ratio.
